(19) United States
(12) Patent Application Publication
(10) Pub. No.: US 2002/0064649 A1
(43) Pub. Date: May 30, 2002

(54) SENSOR ELEMENT OR ACTUATOR ELEMENT HAVING AN ANTI-ADHESIVE SURFACE COATING

(76) Inventors: MANFRED LEMBKE, GERLINGEN (DE); HANS HECT, KORNTAL-MUENCHINGEN (DE); DIRK WELTING, LEONBERG (DE); LUTZ MUELLER, GERLINGEN (DE); THOMAS BRINZ, BISSINGEN UNTER DER TECK (DE)

Correspondence Address: KENYON & KENYON, ONE BROADWAY, NEW YORK, NY, 10004, US

(21) Appl. No.: 09/416,715

(22) Filed: Oct. 13, 1999

(30) Foreign Application Priority Data
Oct. 14, 1998 (DE) 19847303.6-52

(51) Int. Cl. B32B 15/04; B32B 17/06

(52) U.S. Cl. 428/336; 428/421; 428/429; 428/447; 428/450

(57) ABSTRACT

A sensor element or an actuator element, in particular for use in motor vehicles, has an anti-adhesive surface coating as a protective layer, to reduce an accumulation, for example, of dirty water, mineral oil, silicon oil, soot, salts, hydrocarbons, dust particles or a combination of at least two of these substances. The surface coating is particularly temperature-stable, firmly adhering, and has a low surface energy. It contains at least one compound, selected from the group of fluorinated polymers, fluorormocers, of the polymeric fluorocarbon resins, of the fluorine-containing silanes, or of partially fluorinated polymers.

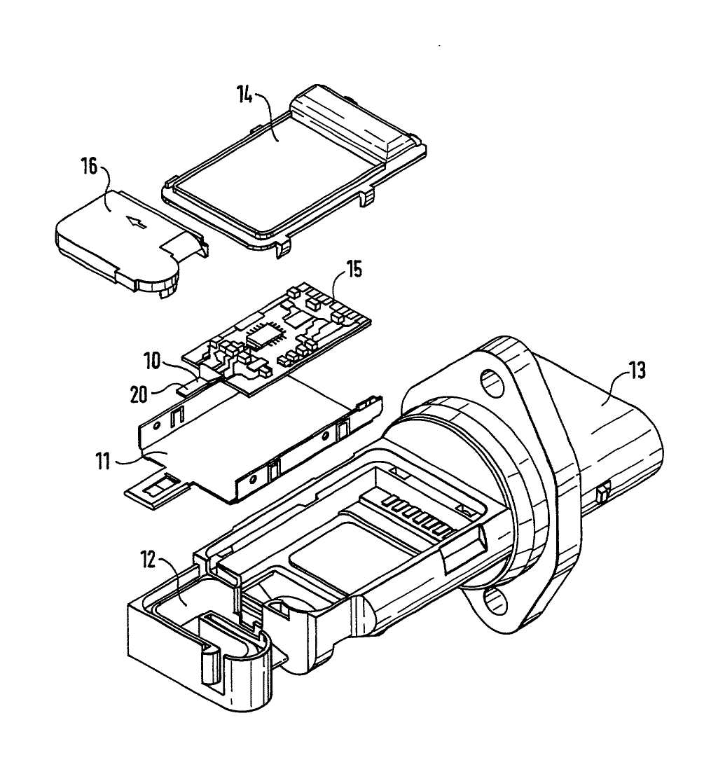

### FIELD OF THE INVENTION

The present invention relates to a sensor element or an actuator element, in particular for use in motor vehicles.

### BACKGROUND INFORMATION

Sensor or actuator elements are known in many variations. An example of one such sensor element is a hot-film air-mass meter. In the operation of sensors or actuators of this kind, the problem often occurs that under unfavorable conditions, such as in an operation in the intake manifold of a motor vehicle, these sensors or actuators become fouled (collect dirt) by the surface accumulation of dirty water, spray water, mineral oil, silicon oil, soot, salts, hydrocarbons, dust particles, etc. in that area of the sensor element that is actually sensitive, resulting in a short-term (for example in the case of spray water) or gradual deterioration in the sensor's signal.

Surface coatings used in the anti-adhesive of textiles to render them water- or oil-repellent, are known, for example, by the commercial name “Scotchgard” of the firm 3M Germany GmbH, Neuss. Fluorinated polymers and partially fluorinated polymers used to prevent the creepage of lubricating oils are also known as “epilamization agents”. Also known are soil-repellent coatings having fluorine-containing silanes on glass and in the form of fluorine-containing polymers, which are precipitated out in plasma processes.

### SUMMARY OF THE INVENTION

An advantage of the sensor- or actuator element in accordance with the present invention over the related art is that in an application under unfavorable conditions, for example in the intake manifold of motor vehicles, soiling or serious degradations in functioning caused by dirty water, spray water, mineral oil, silicon oil, soot, hydrocarbons, salts or dust particles on the sensor- or actuator element, can be substantially reduced, so that its service life and unrestricted performance reliability is ensured at all times, even under unfavorable conditions.

This is particularly true when the surface of, for example, sensor- or actuator components manufactured using silicon micromechanics, is made of dielectric layers, such as of silicon dioxide, silicon nitride, silicon, glass, ceramics, polymers or metals, which exhibit a high surface energy and, therefore, are rendered readily hydrophilic (easily wetted) by the foreign matter or impurities. In the case of the sensor- or actuator elements in accordance with the present invention, having an anti-adhesive and, in particular, organic or fluorine-containing surface coating as a protective layer, this kind of soiling or serious degradation of functioning is minimized by reducing the surface energy.

Furthermore, for example, the thickness of the anti-adhesive surface coating can be adjusted within a broad range of about 10 nm to 10 μm, so that the sensor signal or actuator signal is not adversely affected by the surface coating. It is also very advantageous that the surface coating is temperature-stable up to at least 200° C. and exhibits only a very low surface energy of 5 to 50 mN/m.

### BRIEF DESCRIPTION OF THE DRAWING

The FIGURE shows a block diagram of a hot-film air-mass meter having a coated sensor element.

### DETAILED DESCRIPTION

In an exploded view, the FIGURE shows a generally known hot-film air-mass meter having a plug connection 13 with connection terminals, an evaluation circuit 15, an electronic space cover 14, a measuring channel cover 16, a support plate 11, a sensor element 10, and an air supply channel 12. This sensor is installed, for example, in an intake manifold of a motor vehicle, the sensor element being supplied via air-supply channel 12 with air and/or gases, which, at the same time, contain a multiplicity of unavoidable contaminants, such as dirty water, spray water, mineral oil, silicon oil, soot, hydrocarbons, salts or dust particles. Sensor element 10 is designed in the form of a chip of patterned silicon, and has a sensitive region located within air-supply channel 12. Sensor element 10 is provided with an anti-adhesive surface coating 20.

Anti-adhesive surface coating 20 is a thin, firmly adhering, temperature-stable, fluorine-containing layer, which, because of its low surface energy, prevents the substances and impurities mentioned above from adhering. Due to the small thickness of surface coating 20 of merely about 10 nm to about 10 μm, the functioning of sensor element 10 or of an actuator element, even when working with functioning principles such as those of thermal anemometers, is, at the same time, not adversely affected in this context. Anti-adhesive surface coating 20 is, in particular, a fluorinated polymer, a fluorormocer, a fluorine-containing silane, a polymeric fluorocarbon resin, or a partially fluorinated polymer.

A solution of a fluorinated polymer and/or of a fluorormocer in a preferably fluorine-containing solvent is applied using dipping methods, or sprayed, spin-coated, brushed, sprinkled, doctored, rolled, or vapor deposited on as surface coating 20 to sensor element 10. Depending on the application method used and the ratio of solvent to fluorinated polymer, the thickness of surface coating 20 is easily adjustable within the range of about 10 nm to 10 μm.

Thus, after drawing off the solvent, an adherent polymer film is formed in a very simple manner on sensor element 10 as a protective layer and anti-adhesive surface coating, whose thickness can be adjusted by varying the ratio of fluorinated polymer to solvent within the broad limits mentioned. Alternatively to coating the surface of sensor element 10 with fluorinated polymers or fluorormocers, the surface of sensor element 10 can also be coated with a fluorinated silane using dipping, spraying or spin-coating methods, as well as through plasma polymerization processes using fluorine-containing substances.

Particularly suited for sensor elements 10 according to the present invention are surface coatings 20, including the products FC 722, FC 732 or FC 725 of the firm 3M Germany GmbH, Neuss, or including the products F2/50 and FK60 of the firm Dr. Tilwich GmbH, 72160 Horb. Also suited, in particular, is a self-synthesized layer, which has added to it the product Foralkyl MAC 8 of the firm Elf Atochem, F-92300 Levallois, a polyfunctional methacrylate, a polymerization initiator and, if needed, a solvent; this solution is then used to coat sensor element 10.

The named surface coatings 20 do not cause any noticeable degradation of the hot-film air-mass meter's measuring signal. Suited, in particular, as sensor elements 10 for surface coating 20 are those of silicon, silicon dioxide, silicon nitride, of ceramic materials, glass, metals or polymers.

Since, in operation, the hot-film air-mass meter exhibits various temperature zones including temperatures of 150° C. to 350° C., it is quite advantageous that a coating of fluorinated polymers decomposes, without leaving residues, at temperatures above 300° C., when the mentioned products of 3M and of Dr. Tilwich are used. Thus, in addition, an area that goes beyond the actual sensor element 10, such as the inner walls of the gas- or air-supply channel 12 and/or of the measuring channel cover, can also be coated with an anti-adhesive surface coating. In a first operation of the hot-air mass sensor, the applied anti-adhesive surface coating is burned away, without leaving residues, at those locations exposed to temperatures of above 300° C.

In the case of hot-air mass sensor 20, the inner walls of air-supply channel 12 are made, in particular, of a glass fiber-reinforced polybutylene-terephthalate injection molding compound and are, thus, likewise suited for an anti-adhesive surface coating having a fluorinated polymer base, further diminishing any degradation in the functioning of the sensor element according to the present invention caused, for example, by contaminants adhering to the inner walls.

Besides the hot-air mass sensor, various other sensors or actuators are suited for using an anti-adhesive surface coating. For this, humidity, climatic, air quality, and temperature sensors come into consideration, in particular. In airbag sensors as well, an anti-adhesive surface coating can be applied to their inner side and/or to the resonant mass, to avoid “sticking”. In addition, in the case of actuators, for example, the baffle plate of an air-intake control or the rotor of a lighting dynamo is suited for an anti-adhesive surface coating. The applied surface coating 20 of the material FC 722 is firmly adhering, in particular on silicon substrates as used for sensor element 10, and passes standard cross hatch (chipping) tests.

What is claimed is:

1. An element for use in a motor vehicle, comprising:
an anti-adhesive surface coating acting as a protective layer.

2. The element according to claim 1, wherein the element is a sensor element.

3. The element according to claim 1, wherein the element is an actuator element.

4. The element according to claim 1, wherein the coating is temperature-stable up to at least 200° C.

5. The element according to claim 1, wherein the coating has a surface energy of 5 to 50 mN/Nm.

6. The element according to claim 1, wherein the coating reduces an accumulation, on a surface of the element, of at least one of: dirty water, mineral oil, spray water, silicon oil, soot, salts, hydrocarbons, and dust particles.

7. The element according to claim 1, wherein the coating contains at least one compound selected from the group consisting of fluorinated polymers, fluorormocers, of the fluorine-containing silanes, of the polymeric fluorocarbon resins, and of partially fluorinated polymers.

8. The element according to claim 1, wherein the coating is one of a fluorine-containing polymer film and a fluorosilane coating.

9. The element according to claim 1, wherein the coating has a thickness of about 10 nm to 10 μm.

10. The element according to claim 1, wherein the coating decomposes, without leaving residues, at temperatures above 300° C.

11. The element according to claim 1, wherein the element is composed of at least one of silicon, silicon nitride, silicon dioxide, glass, metal, a polymer and a ceramic.

12. The element according to claim 2, wherein the sensor element is integrated in a hot-film air-mass meter.

13. The element according to claim 2, wherein the sensor element is integrated in one of a humidity sensor, a climatic sensor, an air quality sensor, a temperature sensor and an airbag sensor.

14. The element according to claim 1, wherein the coating is applied to inner walls of components.

15. The element according to claim 1, wherein the coating is applied to inner walls of one of: gas-supply channels and air-supply channels.

16. The element according to claim 1, wherein the coating is applied to inner walls of housing groups surrounding the element.

17. The element according to claim 1, wherein the coating is firmly adhering and passes a cross hatch test.
